(19) United States
(12) Patent Application Publication
(10) Pub. No.: US 2024/0198506 A1
(43) Pub. Date: Jun. 20, 2024

(54) Method for monitoring the quality of screwing or drilling operations including unsupervised machine learning

(71) Applicants: ETABLISSEMENTS GEORGES RENAULT, SAINT HERBLAIN (FR); NANTES UNIVERSITE, NANTES Cédex 1 (FR)

(72) Inventors: Philippe Leray, SAFFRE (FR); Mathieu Ritou, NANTES (FR); Mahmoud Ferhat, SAINT HERBLAIN (FR)

(21) Appl. No.: 18/555,409

(22) PCT Filed: Apr. 14, 2022
(86) PCT No.: PCT/EP2022/060114

§ 371 Date: Oct. 13, 2023

(30) Foreign Application Priority Data
Apr. 16, 2021 (FR) FR2103983

(51) Int. Cl. B25F 5/00; G06N 20/00

(52) U.S. Cl. CPC B25F 5/00; G06N 20/00; G05B 2219/32177

(57) ABSTRACT

A method for controlling quality of screwing or drilling operations performed by means of a tool. The method includes machine learning of a statistical model of the unsupervised type.

### 1. CROSS-REFERENCE TO RELATED APPLICATIONS

This Application is a Section 371 National Stage Application of International Application No. PCT/EP2022/060114, filed Apr. 14, 2022, which is incorporated by reference in its entirety and published as WO 2022/219153 A1 on Oct. 20, 2022, not in English.

### 2. FIELD OF THE INVENTION

The field of the invention is that of controlling the quality of operations performed in industrial production, such as for example screwing or drilling operations, by implementing smart control methods using a model of the machine learning type.

### 3. PRIOR ART

In many industrial fields, in particular in the automobile field, components are assembled by screwing.

Screwing consists of rotating a screw until a tightening criterion, which may for example be a torque or a tightening angle, reaches a predetermined threshold. The torque developed by a screwing machine follows the resisting torque of the screw which, in general, is a linear function of the angle.

The functional objective of screwing is to install a certain tension in the screw body, this tension making it possible to achieve the assembly of two components.

However, it may happen that screwing does not take place correctly and that the tension installed in the screw at the end of screwing is not satisfactory so that the assembly is defective.

This may in particular happen following faulty engagement of the screw in the thread (crossed thread). The torque applied by the screwing machine may then be observed rising to the required torque level, giving the impression that tightening has been suitably effected, whereas the assembly tension in the screw is insufficient or even zero. The screwing is then considered to be positively good whereas it is not correct; this is a false positive.

Other defects may happen during screwing with similar consequences: jamming in the threads, stick-slip, etc.

In many industrial fields, in particular in the aeronautical field, drilling or counter-drilling of components is carried out.

Drilling consists in producing a hole in a component.

Counter-drilling consists in drilling a plurality of components pressed against each other before assembling them together.

In the aeronautical industry, counter-drilling is much used to produce holes in components to enable a screw or rivet to be placed, next making it possible to assemble these components to produce avionic structures.

These holes are more and more frequently produced in stacks of materials of different natures: aluminium or titanium alloy, carbon fibre, etc.

Drilling systems make it possible to measure in real time the axial force and the cutting torque to which the bit is subjected.

These values follow a change according to the depth of penetration of the bit in the material that represents the variation in hardness of the various materials present in the stack.

The axial torques and forces are rather constant, in the form of a level stage, when the tip of the bit progresses in a thickness of homogeneous material. On the other hand, they change greatly when the tip of the bit passes from one material to another.

In principle these changes in axial torque and axial force are repeatable from one drilling to the next. A drift in these changes may represent premature wear of the bit or a blockage of swarf with consequences on the quality of the hole (geometry, surface state, hole entry or exit burrs, flaking of the carbon fibre).

The production and quality-control departments of these industries therefore implement methods aimed at detecting defects by analysing the physical data (or quantities) recorded during each screwing or drilling. These data are normally referred to as screwing or drilling report or screwing or drilling results.

These methods rely on machine learning or neural network techniques and make it possible to issue, in real time, an alert intended for method operators or technicians in order to be able to isolate or correct the non-conforming production operations, i.e. those the quality of which is not satisfactory.

Techniques for controlling operation quality of the supervised-learning model type are known. Implementation of these techniques comprises two phases, namely a learning phase and a production control phase.

The learning is based on the training of a statistical model, from results of screwing or drilling operations, to define groups (or clusters) of results. Prior to this learning, an operator must label, one by one, the results of operations taken into account. This labelling phase consists, for the operator, in analysing each operation result to term it a good or bad result. After the operator has labelled all the results taken into consideration, they trigger the machine learning of the supervised model so as to make it able to determine the label of the new results.

During the production control phase, as soon as a new operation is performed, the result thereof is analysed by the control system, which is in a position to automatically attribute a label to it.

Such a technique is advantageous in that it makes it possible, in production, to inform automatically, i.e. without the intervention of a control technician, whether the result of a new operation is good or bad.

However, learning of the supervised type is constraining. This is because, for a model to be reliable, several hundreds of operation results must be taken into consideration. This supposes that the method technician reviews all these operation results and rules on the conformity thereof (i.e. good or bad character) prior to the learning. This task is lengthy and therefore expensive.

In addition, for a supervised model to be effective, it is necessary for all the operation results intended to train it to contain a number of results of each type (good and bad) liable to be encountered during the use of the model for classifying the results.

However, when such a model is commissioned, the results of operations available are those issued during first production operations and these results are in the majority good results.

Furthermore, even if a large number of results of different types are provided in the learning phase, these supervised models are generally designed to classify the new incoming results in production mode in the types identified during learning. However, as some types may be unknown or missing during the learning phase, the model cannot detect the emergence of a new type of result not previously encountered.

Finally, the majority of these models require a sufficiently long training time to fulfil the objective with considerable precision. In addition, as the precision is highly proportional to the complexity of the model and is crucial in an industrial context, the capacity for interpretation of the results is often impaired.

### 4. SUMMARY

An exemplary embodiment of the present disclosure relates to a method for controlling the quality of screwing or drilling operations performed by means of a tool, said method comprising:
a step of machine learning of a model, said initial machine learning step comprising:
   a step of collecting initial results of screwing or drilling operations recorded during a plurality of screwing or drilling operations;
   a step of obtaining, by means of said model, at least one statistical representation of at least some of the initial results;
   a step of labelling said at least one statistical representation with at least one of said following labels:
      labelled statistical representation of conforming results;
      labelled statistical representation of non-conforming results;
a step of automatic production control of the quality of screwing or drilling operations, said automatic production control step being implemented at the end of each operation and comprising:
   a step of collecting the new result of the screwing or drilling operation recorded during the operation in question;
   a step of automatic allocation of said new result of the operation in question to the at least one statistical representation;
   a step of issuing an alert if the new operation result is allocated to a non-conforming statistical representation.

According to an exemplary embodiment of the present disclosure, said learning of the model is of the unsupervised type.

Thus an exemplary embodiment of the present disclosure relates to a technique for controlling the quality of results of screwing or drilling operations including unsupervised machine learning.

This technique makes it possible to simplify and reduce the time necessary for learning, or more precisely where applicable for the preprocessing of the results of operations that is necessary for the automatic control of results of operations. This is because, rather than labelling all the results of operations as in the prior art for supervised learning, the operator has to label only the statistical representations to which the results are allocated.

According to one possible feature, said production control step comprises a step of rejecting the new results of operations that cannot be allocated to one of said statistical representations, and a step of recording the rejected results as exception results.

It is thus possible to reject the results of operations where the probability of belonging to the normal laws already established is low.

In this case, a method according to an exemplary embodiment of the present disclosure preferentially comprises a step of issuing an alert when a new result obtained at the end of a screwing or drilling operation is identified as an exception result during said rejection step.

According to one possible feature, said step of obtaining at least one statistical representation uses a statistical model of the Gaussian mixture model type, said at least one statistical representation being a multivariate normal law.

According to another variant, said step of obtaining at least one statistical representation uses a statistical model of the k-means type, said at least one statistical representation being a mean vector.

According to a possible variant, said statistical model of the Gaussian mixture type calculates, during said step of obtaining a statistical representation, a plurality of initial multivariate normal laws each representing a cluster of initial results of screwing or drilling operations, each of said initial multivariate normal laws having a weight, said rejection step comprising a step of calculating the probability density of each new result of a screwing or drilling operation obtained during said production automatic control step and a step of comparing this density with a predetermined global rejection threshold dependent on the weight of each of said initial multivariate normal laws.

According to one possible variant, said weight of an initial multivariate normal law represents the number of results of screwing or drilling operations allocated to said multivariate normal law with respect to the total number of results of screwing or drilling operations taken into account.

According to one possible variant, said classification step is followed by a step of updating the weight of all of said initial multivariate normal laws.

According to one possible variant, said classification step is followed by a step of updating said predetermined global rejection threshold.

According to one possible variant, a method according to an exemplary embodiment of the present disclosure comprises a step of updating said learning, said updating step being implemented during said automatic production control step and comprising a step of updating the obtaining of a statistical representation of the initial results in the form of at least one multivariate normal law, said updating step taking account of the new operation results identified as exception results for generating at least one new multivariate normal law.

According to one possible variant, during said step of updating said learning, said statistical model of the Gaussian mixture type calculates new multivariate normal laws, from the exception results, each representing a new cluster of results of operations, said step of updating said learning comprising a step of calculating the new weight of said initial and new multivariate normal laws.

According to one possible variant, said step of updating said learning generates new multivariate normal laws, from the new results of operations and the initial results of operations, each representing a new cluster of results of screwing or drilling operations, said new multivariate normal laws being substituted for the initial multivariate normal laws.

According to one possible feature, a method according to an exemplary embodiment of the present disclosure comprises a step of counting the number of new operation results identified as exception results, said step of updating said learning being implemented when the number of operation results identified as exception results reaches a predetermined threshold.

According to one possible feature, each operation result is a series of data, said series of data being the subject of preprocessing consisting in doing, on a series of data, a series of predetermined calculations each leading to an extracted characteristic, said extracted characteristics being taken into consideration for implementing said step of obtaining a statistical representation of the initial results in the form of at least one multivariate normal law.

According to one possible feature, said extracted characteristics are taken into consideration by said statistical model of the Gaussian mixture type for generating said multivariate normal laws each representing a cluster of results of screwing or drilling operations.

According to one possible feature, said series of data belong to the cluster comprising:
a torque according to an angle or to a depth of drilling or to time;
an angle as a function of time;
a current, in particular of a motor rotating a screwing tool or rotating or translating a cutting tool according to an angle or to a depth of drilling or to time;
a force according to an angle or to a depth of drilling or to time.

According to one possible feature, a method according to an exemplary embodiment of the present disclosure comprises a step of selecting, in each of said series, a portion of data of interest, said portion of data of interest being the subject of said preprocessing. An exemplary embodiment of the present disclosure also relates to a device for controlling the quality of screwing or drilling operations performed by means of a tool, said device comprising:
means for machine learning of a model, said initial machine learning means comprising:
   means for collecting initial results of screwing or drilling operations recorded during a plurality of screwing or drilling operations;
   Means for obtaining, by means of said model, at least one statistical representation of at least some of the initial results;
   means for labelling said at least one statistical representation with at least one of said following labels:
      labelled statistical representation of conforming results;
      labelled statistical representation of non-conforming results;
means for automatic production control of the quality of screwing or drilling operations, said automatic production control means being able to be used at the end of each operation and comprising:
   means for collecting the new result of the screwing or drilling operation recorded during the operation in question;
   means for automatic allocation of said new result of the operation in question to the at least one statistical representation;
   means for issuing an alert if the new operation result is allocated to a non-conforming statistical representation;
      said learning of said model being of the unsupervised type.

According to one possible feature, a device according to an exemplary embodiment of the present disclosure comprises means for rejecting the new results of operations that cannot be allocated to one of said statistical representations, and means for recording the rejected results as exception results.

According to one possible feature, a device according to an exemplary embodiment of the present disclosure comprises a step of issuing an alert when a new result obtained at the end of a screwing or drilling operation is identified as an exception result by said rejection means.

According to one possible feature, said means for obtaining at least one statistical representation uses a statistical model of the Gaussian mixture model type, said at least one statistical representation being a multivariate normal law.

According to one possible feature, said means for obtaining at least one statistical representation uses a statistical model of the k-means type, said at least one statistical representation being a mean vector.

According to one possible feature, said statistical model of the Gaussian mixture type is able to calculate a plurality of initial multivariate normal laws each representing a cluster of initial results of screwing or drilling operations, each of said initial multivariate normal laws having a weight, said rejection means comprising means for calculating the probability density of each new result of a screwing or drilling operation obtained in production and means for comparing this density with a predetermined global rejection threshold dependent on the weight of each of said initial multivariate normal laws.

According to one possible feature, said weight of an initial multivariate normal law represents the number of results of screwing or drilling operations allocated to said multivariate normal law with respect to the total number of results of screwing or drilling operations taken into account.

According to one possible feature, a device according to an exemplary embodiment of the present disclosure comprises means for updating the weight of all of said initial multivariate normal laws.

According to one possible feature, a device according to an exemplary embodiment of the present disclosure comprises means for updating said predetermined global rejection threshold.

According to one possible feature, a device according to an exemplary embodiment of the present disclosure comprises means for updating the at least one statistical representation of the initial results in the form of at least one multivariate normal law obtained by said learning means, said updating means taking account of the new results of operations identified as exception results for generating at least one new multivariate normal law.

According to one possible feature, said updating means using said statistical model of the Gaussian mixture type for calculating new multivariate normal laws, from the exception results, each representing a new cluster of results of operations, said means for updating said learning comprising means for calculating the new weight of said initial and new multivariate normal laws.

According to one possible feature, said updating means generate new multivariate normal laws, from the new results of operations and the initial results of operations, each representing a new cluster of results of screwing or drilling operations, said new multivariate normal laws being substituted for the initial multivariate normal laws.

According to one possible feature, a device according to an exemplary embodiment of the present disclosure comprises means for counting the number of new results of operations identified as exception results, said updating means being used when the number of results of operations identified as exception results reaches a predetermined threshold.

According to one possible feature, each operation result is a series of data, said device comprising means for preprocessing said series of data consisting in doing, on a series of data, a series of predetermined calculations each leading to an extracted characteristic, said extracted characteristics being taken into consideration by said means for obtaining a statistical representation of the initial results in the form of at least one multivariate normal law.

According to one possible feature, said extracted characteristics are taken into consideration by said statistical model of the Gaussian mixture type for generating said multivariate normal laws each representing a cluster of results of screwing or drilling operations.

According to one possible feature, said series of data belong to the cluster comprising:
a torque according to an angle or to a depth of drilling or to time;
an angle as a function of time;
a current, in particular of a motor rotating a screwing tool or rotating or translating a cutting tool according to an angle or to a depth of drilling or to time;
a force according to an angle or to a depth of drilling or to time.

According to one possible feature, a device according to an exemplary embodiment of the present disclosure comprises means for selecting, in each of said series, a portion of data of interest, said portion of data of interest being taken into account by said preprocessing means.

An exemplary embodiment of the present disclosure also relates to a computer program product, comprising program code instructions for implementing a method according to any one of the variants disclosed above, when said program is executed on a computer. An exemplary embodiment of the present disclosure also relates to a storage medium that can be read by computer and is non-transient, storing a computer program product according to claim 35.

### 5. DESCRIPTION OF THE FIGURES

Further features and advantages of the disclosure will become apparent on reading the following description of specific embodiments, which is given merely as a non-limiting example for illustration purposes, and the accompanying drawings, in which:

FIG. 1 illustrates an example of a table of an operation result;

FIG. 2 illustrates an example of a screwing curve;

FIG. 3 illustrates the functional blocks of an example of a control device according to an exemplary embodiment of the present disclosure;

FIG. 4 illustrates learning of a method according to an exemplary embodiment of the present disclosure;

FIG. 5 illustrates the use in production of a method according to an exemplary embodiment of the present disclosure;

FIG. 6 illustrates a first variant of updating the learning of a method according to an exemplary embodiment of the present disclosure;

FIG. 7 illustrates a first variant of updating the learning of a method according to an exemplary embodiment of the present disclosure;

FIG. 8 illustrates an example of architecture of a quality control system according to an exemplary embodiment of the present disclosure.

### 6. DESCRIPTION OF SPECIFIC EMBODIMENTS

### 6.1. Quality Control Device

The disclosure relates to a technique for controlling the quality of screwing or drilling operations using a statistical model of the unsupervised machine learning type.

The screwing or drilling operations are performed with a work device conventionally comprising a tool, such as a screwing machine or a drilling machine, and a controller provided with an MMI for controlling the tool.

The tool and/or the controller make it possible in particular to record, during the performance of each operation, an operation result.

During a screwing operation, various physical quantities can be measured by the tool and/or the controller to monitor the development of the operation underway and to detect the finalisation thereof by the reaching of objective thresholds by some of the physical quantities measured.

In the example described here, it will be considered that the physical quantities measured during a screwing operation comprise the screwing angle and the screwing torque.

During a drilling operation, the physical quantities measured are in particular for example the torque and the axial thrust on the tool generated by the cutting tool.

During a screwing operation, control means incorporated in the tool and/or in the controller make it possible to measure and record physical quantities on the basis of a predetermined frequency of acquisition, these physical quantities being able to comprise one or more of the following quantities: the screwing angle, the screwing torque or the current of the tool motor.

The tool and/or the controller can then for example record, according to the rate of its microprocessor, couplets comprising a screwing angle value and a screwing torque value. A screwing-angle and screwing-torque couplet corresponds to the result of a measurement of angle and of screwing torque at the same instant

During a screwing operation, these couplets are recorded in the form of a table of values and can give rise to the construction of a screwing curve that an operator can view on a monitor.

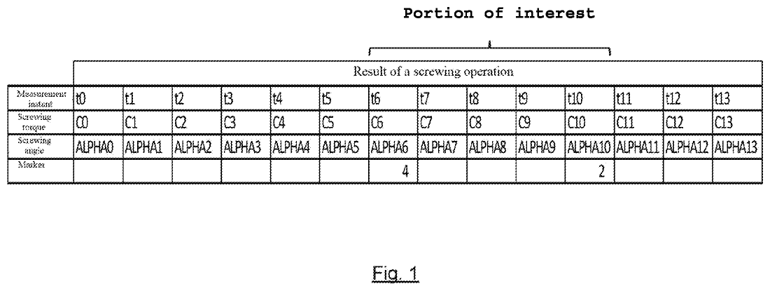

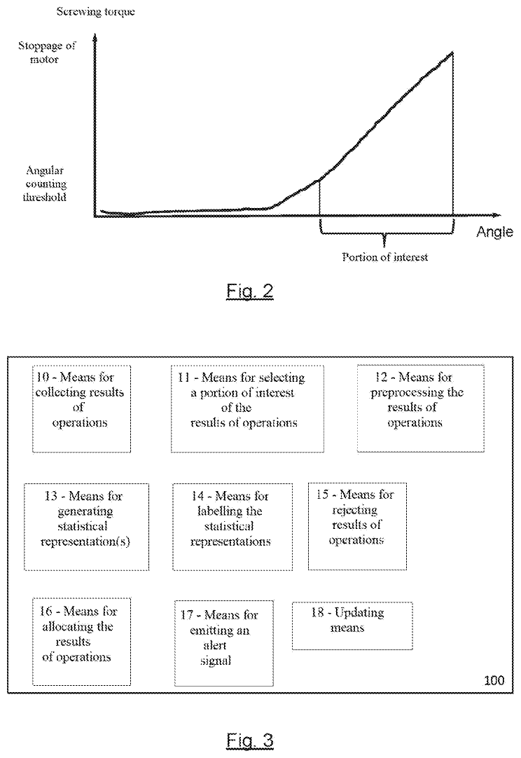

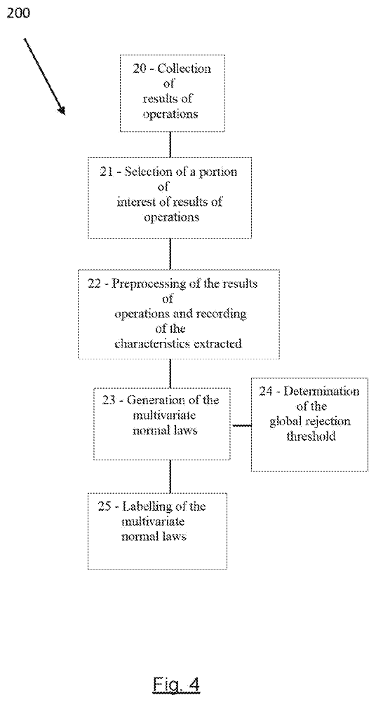

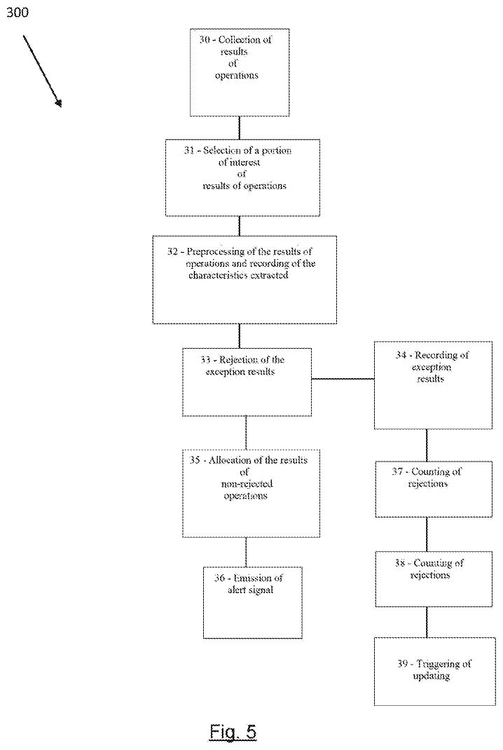

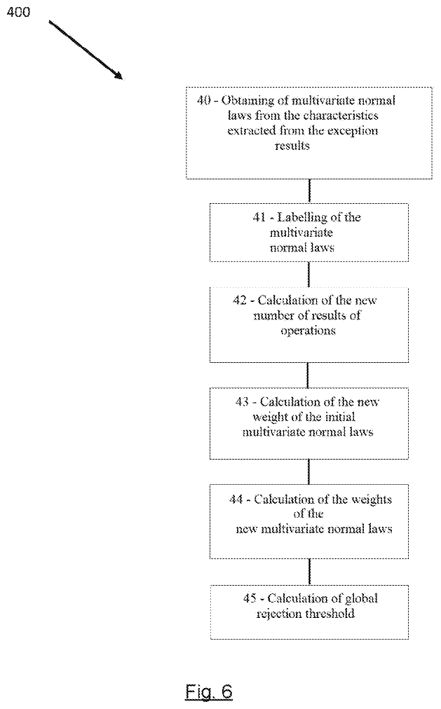

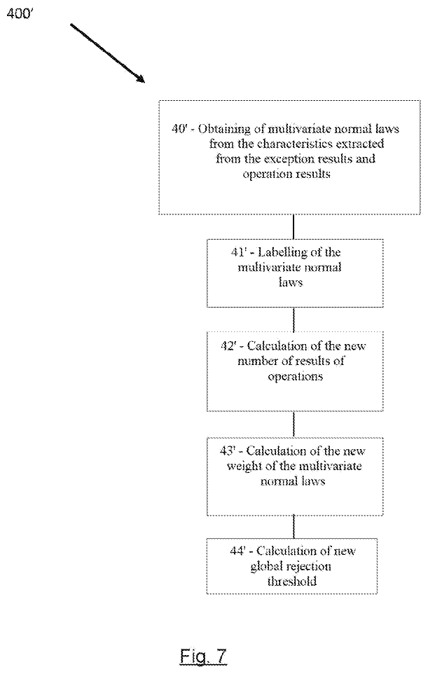

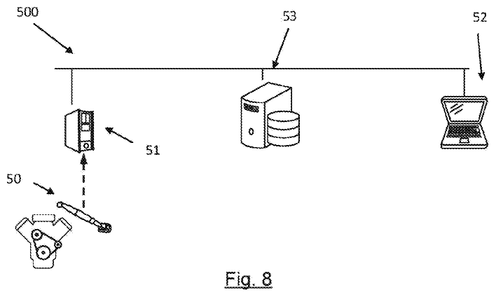

FIG. 1 illustrates a table of values in which the couplets measured during a screwing operation are recorded. FIG. 2 illustrates an example of a screwing curve.

The result of a screwing is therefore in this example a table of values listing the screwing-angle/screwing-torque couplets recorded during a screwing operation. Such a table therefore contains couplets that constitute a series of data, also referred to as series of time data.

In the context of a drilling, the physical quantities measured generally comprise the torque and the axial force generated by the cutting tool as a function of the depth reached by the tip of the cutting tool (the bit).

The result of a screwing is therefore in this example a table of values listing the drilling-depth/torque couplets and a table of values listing the drilling-depth/axial force values recorded during a screwing operation. Each table therefore contains couplets that constitute a series of data, also referred to as series of time data.

An operation result is therefore one (in the case of a screwing) or several (in the case of a drilling) series of data recorded during the performance of the operation.

This operation result is next analysed by a quality control device 100 that makes it possible to check whether the operation performed is or is not in conformity with the quality level expected.

A quality control device according to an exemplary embodiment of the present disclosure comprises:
functional means 10 for connecting results of operations;
functional means 11 (optional) for selecting a portion of interest in each operation result;
functional means 12 for preprocessing the operation results or portions of interest;
functional means 13 for generating at least one statistical representation (multivariate normal laws or mean vectors) representing clusters of operation results;
functional means 14 for labelling statistical representations;
functional means 15 (optional) for rejecting non-allocatable operation results;
functional means 16 for allocating results of operations;
functional means 17 for issuing an alert signal;
functional means 18 for updating the statistical representations.

Such a device comprises in particular a processing unit equipped for example with a microprocessor, a random access memory, and a read only memory containing a computer program comprising program code instructions for executing a method according to an exemplary embodiment of the present disclosure.

These functional means are not described here in any more detail. They conventionally incorporate hardware components and software modules. The respective functionalities thereof will be described in more detail hereinafter with the description of the control method according to an exemplary embodiment of the present disclosure.

### 6.2. Quality Control Method

A working device is used for successively performing, on a workstation, a plurality of operations of the same type. For example, a screwing operation of one type corresponds to the tightening of a given assembly, such as for example that of a screw securing a cylinder head on an engine, which is reproduced a plurality of times successively on a production line.

When commissioned, a quality control device according to an exemplary embodiment of the present disclosure must be trained for controlling the quality of the type of operation for which it must make it possible to provide the quality control.

For this purpose, a quality control method according to an exemplary embodiment of the present disclosure comprises an initial learning step of the control module, the learning being of the unsupervised type.

The preferential embodiment uses a model of the Gaussian mixture type leading to the generation of statistical representations of operation results in the form of multivariate normal laws.

### 6.2.1. Initial Learning of the Model

The initial learning step 200 consists, from a plurality of initial results of operations, in obtaining at least one statistical representation of the initial results in the form of at least one initial multivariate normal law, each law representing an initial cluster of results. Each multivariate normal law is next labelled as representing conforming results or non-conforming results.

In production, each new operation result is allocated to one of the multivariate normal laws so that a conforming or non-conforming result label is attributed to it.

The initial learning step 200 of the model comprises a plurality of steps.

i. Collection

The learning comprises firstly a step 20 of collecting a plurality of initial results of operations.

The initial results of operations are the results of operations obtained by performing a plurality of operations of a type for which it is wished subsequently to control the quality by implementing the quality control method. An operation result is for example one or more tables of values of a plurality of measured physical quantities constituting a series of data, or time series, as indicated previously, such as for example the table shown at FIG. 1.

ii. Selection of Portions of Interest

It is possible to achieve the learning of the model on all the series of data of the initial results. It is however more effective to select, in the series of data of each operation result, a portion of interest, corresponding to a part of an operation in which it is necessary to take an interest in particular. Selecting a portion of interest makes it possible to reduce the number of data taken into consideration while concentrating on an important portion and thus to simplify the model, for example to reduce the computing time.

The learning can therefore comprise an optional step 21 of selecting a portion of interest in the series of data of each initial operation result.

In the context of a screwing operation, a table of operation results can comprise a certain number of markers corresponding to characteristic instants of a screwing operation. In this case, the markers taken into consideration in this example are:
the angle counting threshold torque;
the motor stop torque of the screwing device.

The angle counting threshold torque corresponds to the value of the screwing torque as from which the value of the screwing angle is measured.

The motor stop torque is the screwing torque at the instant when the screwing device stops to mark the end of the screwing operation.

The markers are here mentioned in a line of the table in the form of FIG. 4 (it could be any other character) in the column corresponding to the angle counting threshold torque being reached, and in the form of the FIG. 2 (it could be any other character different from the previous market) in the column corresponding to the motor stop torque being reached.

The step of selecting a portion of interest therefore consists, for each operation result, in extracting from the series of data the data located between the markers.

iii. Preprocessing: Extraction of the Characteristics

The learning next comprises a step 22 of preprocessing of the series of data (or portions of interest of series of data).

Such a preprocessing may for example consist in performing, on each series of data or portion of interest, a series of predetermined calculations each resulting in an extracted characteristic.

A series of calculations may for example come from a library such as the tsfresh library supported by Python. Other libraries could be used, such as for example SciPy.

The series of a number d of predetermined calculations made on each series of data or portion of interest (coming from an operation result) gives a vector Xi comprising d extracted characteristics. Supposing that the number of series of data (or portions of interest of series of data) taken into consideration is equal to N, a matrix X of data of dimensions Nxd is obtained at the end of the preprocessing. These vectors of extracted characteristics are preferentially recorded to serve subsequently, for example for updating the model, as will be explained in more detail subsequently.

iv. Obtaining a Set of Statistical Representations of the Initial Operation Results in the Form of Initial Multivariate Normal Law(s).

The learning next comprises a step 23 of obtaining a statistical representation of the initial results in the form of at least one initial multivariate normal law. Each multivariate normal law represents a group (or cluster) of initial operation results. In this embodiment, this step uses a statistical model of the Gaussian mixture model (GMM) type.

The GMM model determines, from the matrix X of extracted characteristics, Kmax proposals for a mixture of initial multivariate normal laws. This mixture contains K multivariate normal laws, K varying from 1 to Kmax.

Each multivariate normal law in a mixture of multivariate normal laws represents a cluster of initial operation results taken into consideration for implementing the learning.

Each multivariate normal law is characterised by:
μk: mean vector of each multivariate normal law
Σk: covariance matrix of each multivariate normal law
πk: weight of each Gaussian of the mixture of the multivariate normal laws

The weight of a multivariate normal law in a mixture of multivariate normal laws represents the number of results of operations allocated to said multivariate normal law with respect to the total number of results of operations taken into account, and the sum of the weights of all the multivariate normal laws of a mixture is equal to 1.

Among the Kmax proposals for a mixture of multivariate normal laws (or statistical representation set), it is next determined which offers the best compromise between precision and simplicity of the model.

For this purpose, the Bayesian information criterion (BIC) is calculated by means of the following formulae:

$$BIC ( K ) = - 2 log p ( X \vert {Θ}_{K} ) + {Ψ}_{K} log ( N ) \\ {K}^{*} = {arg min}_{K} BIC ( K )$$

### With:

K Number of normal laws envisaged in the various mixture proposals.
X Matrix of characteristics extracted from the results used for learning
Θ_{K}={πk, μk, Σk} with kϵ{1, . . . , K} P parameters of the mixture of multivariate normal laws
πk Weight of each Gaussian of the mixture of the multivariate normal law
ψ_{K}=K+Kd+Kd(d−1)/2 Number of parameters of each proposal
N Number of operation results used for the learning
K* Optimum number of initial multivariate normal laws

At the end of the initial learning, the GMM supplies a mixture of a number K* of initial multivariate normal laws in which each initial multivariate normal law represents a cluster of initial operation results.

These elements are not further detailed here since they are moreover known in the prior art.

v. Labelling of the Initial Groups of Operation Results

The learning continues with the implementation of a step 25 of labelling the multivariate normal laws.

During the labelling, each multivariate normal law is attributed a label, for example one of the following labels:
labelled multivariate normal laws of conforming results;
labelled multivariate normal laws of non-conforming results.

For this purpose, the system procures for the method technician, for each multivariate normal law, an operation result that led to the generation of this law, in the form of an operation result curve, a table of operation results or other, so that they can determine whether this result is conforming or not. The multivariate normal law is labelled accordingly. Thus, in this unsupervised method, the technician must label only one operation result per cluster rather than all the operation results.

A conforming or non-conforming label is thus associated, by an operator via an MMI interface, with each multivariate normal law. Information about the nature of the defect encountered for the operations that led to each multivariate normal law can thus be given (stick-slip, jamming, etc).

The labelling of the multivariate normal laws marks the end of the initial learning of the model.

When the initial learning of the model has ended, the quality control method can be implemented during production to check, in real time, at the end of each operation, whether or not it conforms to the level of exactitude.

vi. Determination of a Global Rejection Threshold

It may happen, during production, that new results of operations collected cannot be allocated to any of the multivariate normal laws generated during the learning.

These operation results allocatable to no existing multivariate normal law may result from a drift of the production process and be detrimental to the quality requirements. They may correspond to the appearance of a new defect in respect of which it is necessary not only to generate an alert but also to prepare monitoring.

The learning of the model is the opportunity to establish a rejection mechanism for detecting, in production, the operation results not allocatable to the multivariate normal laws generated during the learning.

It is known that it is possible to check whether an operation result Xᵢ can be allocated to a multivariate normal law by comparing its probability density fₖ (Xᵢ) with a threshold thx particular to said law.

### With:

$${f}_{k} ( {X}_{i} ) = p ( {X}_{i} \vert k ) \\ {th}_{k} = \frac{τ}{{( 2 π )}^{d / 2} \cdot {\vert {Σ}_{k} \vert}^{1 / 2}}$$

d Number of predetermined calculations
Σₖ Covariance matrix for the Gaussian in question
T is selected between 1 and 10%, the higher t is, the more the allocation of a result to a normal law implies that this result is centred on the normal law. If this normal law represents conformity to the quality requirements or a given physical defect, then selecting a high t amounts to adopting, as belonging to this law, the physical results close to the quality requirement or close to the physical defect.

If:

$${f}_{k} ( {X}_{i} ) < {th}_{k}$$

Then it is considered that the operation result Xᵢ does not belong to said normal law.

In the context of the present disclosure, the objective of the rejection mechanism is to determine whether an operation result Xᵢ is liable to belong no longer to a single normal law but to the mixture of several normal laws.

It is therefore envisaged establishing a global threshold particular to the mixture of normal laws with which the global probability density f (Xᵢ) of an operation result will be compared Xᵢ.

The objective sought in establishing a global rejection threshold is firstly allowing verification that a new operation result belongs to one of the multivariate normal laws in a single control operation and secondly making the rejection mechanism more reliable by making more strict the allocation of the new results to the least significant normal laws and facilitating the allocation of the new results to the most significant normal laws.

Thus the weight of the various normal laws is taken into account for calculating the global threshold during step 24 of determining the global rejection threshold.

The global rejection threshold thg is next calculated as follows:

$$thg = {\sum }_{k = 1}^{K} π - k . {th}_{k}$$

Use of this global threshold is explained below

### 6.2.2. Production Quality Control

During each operation performed in production with the tool, the tool and/or the controller conventionally records the operation result. This operation result is transmitted for control to the quality control device so that a conforming or non-conforming label is attributed to each operation result.

i. Collection of a New Operation Result

The production quality control 300 therefore comprises a step 30 of collecting the new operation result in the form of a series of data.

ii. Selection of a Portion of Interest

This collecting step 30 is optionally followed by a step 31 of selecting a portion of interest in the series of data of the new operation result. This step is implemented when it was implemented during the initial learning of the model.

iii. Preprocessing

The series of data, or the portion of interest, is next preprocessed in a preprocessing step 32 equivalent to the preprocessing step implemented during the initial learning.

At the end of the preprocessing step, the preprocessing means generate a vector Yᵢ of extracted characteristics that is recorded in order optionally to be used during following steps. This vector can be used in the rejection mechanism, in the classification if it is not an exception result, or during the updating of the model. Xᵢ is a vector of characteristics extracted from an initial operation result whereas Yᵢ is a vector of characteristics extracted from a new operation result recorded in production.

iv. Rejection of Exception Result

The production quality control continues with the (optional) implementation of a step 33 of rejecting the new operation result if it cannot be allocated to any of the labelled multivariate normal laws, and where applicable a step 34 of recording the rejected result as an exception result.

This rejection step 33 consists in rejecting any new operation result where it is known that it cannot be allocated to any of the multivariate normal laws generated during the learning phase.

The step of rejecting the exception results comprises:
calculating the global probability density f(Yᵢ) of the new operation result Yᵢ:

$$f ( {Y}_{i} ) = {\sum }_{k = 1}^{K} {π}_{k} {f}_{k} ( {Y}_{i} )$$

comparing the probability density f(Yᵢ) of the new result Y with the global rejection threshold thg,
rejecting the new operation result if its probability density f(Yᵢ) is below the global rejection threshold thg,

$$f ( {Y}_{i} ) < thg$$

recording the new operation result as an exception result if it is rejected.
   v. Allocating a New Non-Rejected Operation Result to an Existing Multivariate Normal Law

### Classification

If the new operation result is not rejected during the rejection step, the production quality control continues with the implementation of a step 35 of automatically allocating the new operation result in question to one of the labelled initial multivariate normal laws.

This step consists in determining the multivariate normal law to which the new operation result can be attributed. The multivariate normal law to which the new operation result is allocated is determined by means of the following equation:

$${C}_{i} = arg {max}_{k} p ( k \vert {Y}_{i} ) = arg {max}_{k} {π}_{k} {f}_{k} ( {Y}_{i} )$$

### Updating of the Weight of the Gaussians and of the Global Rejection Threshold

Each time a new operation result is allocated to one of the multivariate normal laws, the weight of the multivariate normal laws is updated in accordance with the formula:

$${π}_{k}^{n + 1} = \frac{N . {π}_{k}^{n} + p ( k \vert {Y}_{i} )}{N + 1}$$

With, if k is different from the index of the cluster receiving the new result, then:

$$p ( k \vert {Y}_{i} ) = 0$$

The global rejection threshold thg is updated accordingly.

vi. Alert in the Case of Rejection or of Allocation to a Non-Conforming Labelled Multivariate Normal Law

If the new operation result in question is allocated to a multivariate normal law not conforming to the quality requirements, then the production quality control method continues by implementing a step 36 of issuing an alert (for example visual and/or audible) for the attention of the method technician and/or the operator working on performing the operations to warn them that the screwing or drilling operation requires correction.

vii. Recurrent Production Quality Control

The production quality control method is implemented whenever a new operation is performed by an operator.

viii. Counting the Exception Results and Updating the Learning

The production quality control method preferentially comprises:
a step 37 of counting the number of exception results recorded;
a step 38 of comparing the number of exception results with a predetermined counting threshold;
a step 39 of triggering an updating of the learning when the counting threshold is reached.

### 6.2.3. Updating the Learning

The method comprises a step 400, 400′ of updating the learning. This step is implemented during the implementation of the production quality control.

The learning is updated throughout the implementation of the production quality control method, for example whenever the number of exception results collected is sufficient. It could also be triggered manually or according to a given time frequency.

The learning can be updated according to two variants.

i. Updating the Learning with the Exception Results Alone

The updating 400 of the learning can be implemented by taking account solely of the exception results.

This updating consists in:
40—obtaining, in an update obtaining step, one or more new multivariate normal laws representing new clusters of results from the exception results previously collected and preprocessed during the rejection step, i.e. from the previously recorded extracted characteristics of these results; the method for obtaining these new multivariate normal laws uses as before the GMM and the calculation of the Bayesian information criterion for determining an optimum mixture of multivariate normal laws.
41—labelling the normal laws obtained by an operator attributing to them, as explained previously, one of the following labels:
   labelled multivariate normal laws of conforming results;
   labelled multivariate normal laws of non-conforming results.

The weights of the initial multivariate normal laws obtained during the initial learning and of the new multivariate normal laws are next updated, as well as the global rejection threshold by implementing the following steps:
42—calculating the new number of results of operations taken into account: N=N^{(prev)}+N^{(new)}
43—calculating the new weight of the initial multivariate normal laws: πₖ=πₖ^{(prev)}·N^{(prev)}/N
44—calculating the new weight of the multivariate normal laws: πₖ=πₖ^{(new)}/N
45—calculating the new value of the global rejection threshold thg. With:
   N^{(prev)} Number of operation results allocated to the multivariate normal laws resulting from the initial learning.
   N(new) number of operation results belonging to the multivariate normal laws obtained during the update.

These operations, which are similar to those performed during the initial learning, are not described in any further detail here.

The new multivariate normal laws resulting from step 40 are associated with the initial multivariate normal laws of the mixture obtained during the initial learning.

The new model thus obtained is applied when the production quality control method is implemented after this update.

At each new update of the learning, new multivariate normal laws that are associated with the previous normal laws comprising the initial laws and the laws generated during previous updates are generated from the exception results.

ii. Updating the Learning with the Exception Results and the Results Allocated to Previous Multivariate Normal Laws

The updating 400′ of the learning can be implemented by taking account of the exception results and the results allocated to existing multivariate normal laws resulting from the initial learning.

This updating consists in:
40′—obtaining, in an obtaining updating step, new multivariate normal laws from the exception results previously collected and preprocessed during the rejection step and the results allocated to the multivariate normal laws resulting from the initial learning, i.e. from the previously recorded extracted characteristics of all the results;
41′—labelling the normal laws obtained by an operator attributing to them, as explained previously, one of the following labels:
   labelled multivariate normal laws of conforming results;
   labelled multivariate normal laws of non-conforming results;
42′—calculating the new number of results of operations taken into account: N=N^{(prev)}+N^{(new)}
43′—calculating the new weight of the new multivariate normal laws;
44′—calculating the new value of the global rejection threshold thg.

The new multivariate normal laws are substituted for the multivariate normal laws resulting from the initial learning.

At each new update of the learning, new multivariate normal laws are generated from the new results of operations and the previous results comprising the initial results and the previous operation results.

iii. Advantages and Drawbacks of the Two Learning Update Solutions

The first type of update has the advantage of a less burdensome computation than the second type of update. It also keeps the clusters obtained during the initialisation and can thus reveal any drift of the new results with respect to these initial clusters.

The Second Type of Update is More Burdensome in Terms of Computation but Offers the advantage of greater precision because the multivariate normal laws obtained during initialisation are re-estimated while taking into account not only the initial results but also the results that were attributed to the clusters associated with these laws during the production classification phase.
6.3. Variant of the k-Means

In a variant, the statistical model used for grouping the operation results in clusters could be different from that of the GMM type.

A model of the k-means type could for example be used. This is because the objective of the k-means is to partition all the results into a number of K clusters, so that the sum of the squares of the distances of each point with respect to the centre of the cluster to which it was allocated is minimum.

Similar to the Gaussian mixture model, this learning involves several calculations of sets of clusters, each of these calculations presupposes a number of clusters selected between 1 and a maximum Kmax.

Next, among the various sets of clusters, the one that offers the best compromise between precision and simplicity is adopted.

Calculating the Silhouette criterion (Sht(K)) allows this evaluation.

$$Sht ( K ) = \frac{1}{N} {\sum }_{i = 1}^{N} Shte ( {X}_{i} ) \\ Shte ( {X}_{i} ) = \frac{{b}_{i} - {a}_{i}}{max ( {a}_{i} , {b}_{i} )} \\ {K}^{*} = arg {max}_{K} Sht ( K )$$

With:
K Number of clusters considered
Xᵢ vector of the extracted characteristics of the result i
Shte(Xᵢ) Silhouette index associated with the vector Xᵢ
aᵢ: the mean of the intra-cluster distance in which Xᵢ is allocated
bᵢ: the distance between Xᵢ and the closest second cluster.

The rejection mechanism will be characterised by:
Calculating a numerical threshold for each cluster
The calculation of this numerical threshold is based on the dispersion of the points that have been allocated to it.
For each result i allocated to a cluster k, the square of the distance Dᵢₖ² is calculated.
Dᵢₖ²=Σⱼ₌₁ⁿdᵢⱼ² where dᵢⱼ² is the distance between the result i and the j^{ème closest result (which belongs to the same cluster as that of the result i).}
The number n is the number of closest n's adjacent to the result i and is determined by the method technician.
The numerical threshold thₖ is fixed by the 100(1−α)% centile of the distribution in distances to the square on the k^{tème} cluster.
   α is similar to the first type risk on the control cards and is determined by the method technician.

For a new result p, if Dₚₖ²>thₖ∀kϵ{1, . . . , K′} then the new result is considered to be of an unknown type.

### 6.4. Example of System Architecture

FIG. 8 illustrates a complete work and quality control system 500 that can for example comprise:
a tool (50 for example a screwing machine or a drilling machine);
a controller 51 able to communicate with the tool 50;
a man machine interface (MMI) 52 comprising for example the form of a PC;
a server 53 able to communicate with the controller and with the MMI.

During the initial learning, the tool makes it possible to perform a plurality of operations and the controller exports the result of each operation to the server.

To implement the learning, the server collects the initial operation results exported by the controller. The server implements the initial learning whereas the MMI is used at the end of learning by the method technician to implement the labelling of the multivariate normal laws.

During the production quality control, the tool makes it possible to perform successive operations. Each operation result is sent by the tool to the server. The server rejects the new operation result as an exception result or allocates it to a conforming or non-conforming multivariate normal law. If the operation result is rejected as an exception result or allocated to a non-conforming multivariate normal law, the server generates the issuing of an alert signal, for example by the MMI.

The technician, through the MMI, demands activation of the updating of the learning.

The updating is implemented by the server. During this updating, the technician labels the new multivariate normal laws by means of the MMI.

In a variant, during the production quality control, the tool makes it possible to perform successive operations. Each operation result is exported by the tool to the server. The server rejects the new operation result as an exception result or allocates it to a conforming or non-conforming multivariate normal law. If the operation result is rejected as an exception result or allocated to a non-conforming multivariate normal law, the server demands the issuing of an alert signal. The server, at a predetermined frequency or when a given number of exception results is reached, demands the activation of the updating of the learning. The updating is implemented by the server. During this updating, the technician labels the new multivariate normal laws by means of the MMI. The various functional means of the quality control device according to an exemplary embodiment of the present disclosure are incorporated in the various items of equipment of these architectures according to requirements.

### 6.5. Variant

In general terms, the present disclosure relates to a method for controlling the quality of screwing or drilling operations performed by means of a tool, said method comprising machine learning of a statistical model of the unsupervised type.

In even more general terms, the present disclosure relates to a method for controlling the quality of any type of industrial operation, said method comprising machine learning of a statistical model of the unsupervised type.

An exemplary embodiment of the present disclosure provides an effective solution to at least some of these various problems.

In particular, at least one embodiment improves the techniques for controlling the quality of operations of the machine learning type.

In particular, an exemplary embodiment provides such a technique that makes it possible to be initialised during learning from a set of results of operations containing a large majority of results conforming to quality requirements and few defects, i.e. a great majority of good results and few bad results.

An exemplary embodiment provides such a technique requiring only a little work on the part of the technician.

An exemplary embodiment provides such a technique able to detect the appearance of results of an unknown type during production.

An exemplary embodiment provides such a technique suitable for allowing updating of the model when results of an unknown type present themselves.

An exemplary embodiment provides such a technique that makes it possible to label clusters and to characterise the physical nature of the defect encountered during operations belonging to these clusters.

An exemplary embodiment provides such a technique that is simple to implement and/or robust and/or multipurpose and/or adaptable.

Although the present disclosure has been described with reference to one or more examples, workers skilled in the art will recognize that changes may be made in form and detail without departing from the scope of the disclosure and/or the appended claims.

1. A method controlling quality of screwing or drilling operations performed by using a tool, said method comprising:
machine learning of a model, said initial machine learning comprising:
collecting initial results of screwing or drilling operations recorded during a plurality of screwing or drilling operations;
obtaining, by using said model, at least one statistical representation of at least some of the initial results;
labelling said at least one statistical representation with at least one of said following labels:
labelled statistical representation of conforming results;
labelled statistical representation of non-conforming results;
automatic production control of the quality of screwing or drilling operations, said automatic production control being implemented at an end of each operation and comprising:
collecting a new result of the screwing or drilling operation recorded during the operation in question;
automatic allocation of said new result of the operation in question to the at least one statistical representation;
issuing an alert in response to the new operation result being allocated to a non-conforming statistical representation;
wherein said learning of said model is of an unsupervised type.

2. The method according to claim 1, wherein said production control comprises rejecting the new results of operations that cannot be allocated to one of said statistical representations, and recording the rejected results as exception results.

3. The method according to claim 2, comprising issuing an alert in response to a new result obtained at the end of a screwing or drilling operation being identified as an exception result during said rejecting.

4. The method according to claim 1, wherein said obtaining at least one statistical representation uses a statistical model of the Gaussian mixture model type, said at least one statistical representation being a multivariate normal law.

5. The method according to claim 1, wherein said obtaining at least one statistical representation uses a statistical model of the k-means type, said at least one statistical representation being a mean vector.

6. The method according to claim 4, wherein said production control comprises rejecting the new results of operations that cannot be allocated to one of said statistical representations, and recording the rejected results as exception results, and wherein said statistical model of the Gaussian mixture type calculates, during said obtaining a statistical representation, a plurality of initial multivariate normal laws each representing a cluster of initial results of screwing or drilling operations, each of said initial multivariate normal laws having a weight, said rejecting comprising calculating a probability density of each new result of a screwing or drilling operation obtained during said production automatic control and comparing this density with a predetermined global rejection threshold dependent on the weight of each of said initial multivariate normal laws.

7. The method according to claim 6, wherein said weight of an initial multivariate normal law represents a number of results of screwing or drilling operations allocated to said multivariate normal law with respect to a total number of results of screwing or drilling operations taken into account.

8. The method according to claim 6, wherein said automatic allocation is followed by a step of updating the weight of all of said initial multivariate normal laws.

9. The method according to claim 6, wherein said automatic allocation is followed by updating said predetermined global rejection threshold.

10. The method according to claim 6, comprising updating said learning, said updating being implemented during said automatic production control and comprising updating the obtaining of a statistical representation of the initial results in the form of at least one multivariate normal law, said updating step taking account of the new results of operations identified as exception results for generating at least one new multivariate normal law.

11. The method according to claim 10, wherein, during said updating said learning, said statistical model of the Gaussian mixture type calculates new multivariate normal laws, from the exception results, each representing a new cluster of results of operations, said step of updating said learning comprising calculating the new weight of said initial and new multivariate normal laws.

12. The method according to claim 10, wherein said updating said learning generates new multivariate normal laws, from the new results of operations and the initial results of operations, each representing a new cluster of results of screwing or drilling operations, said new multivariate normal laws being substituted for the initial multivariate normal laws.

13. The method according to claim 10, comprising counting a number of new operation results identified as exception results, said updating said learning being implemented when the number of operation results identified as exception results reaches a predetermined threshold.

14. The method according to claim 1, wherein each operation result comprises a series of data, said series of data being a subject of preprocessing comprising doing, on the series of data, a series of predetermined calculations each leading to an extracted characteristic, said extracted characteristics being taken into consideration for implementing said obtaining the statistical representation of the initial results in the form of at least one multivariate normal law.

15. The method according to claim 6, wherein each operation result comprises a series of data, said series of data being a subject of preprocessing comprising doing, on the series of data, a series of predetermined calculations each leading to an extracted characteristic, said extracted characteristics being taken into consideration for implementing said obtaining the statistical representation of the initial results in the form of at least one multivariate normal law, and wherein said extracted characteristics are taken into consideration by said statistical model of the Gaussian mixture type for generating said multivariate normal laws each representing a cluster of results of screwing or drilling operations.

16. The method according to claim 14, wherein, said series of data belong to a group consisting of:
a torque according to an angle or to a depth of drilling or to time;
an angle as a function of time;
a current, in particular of a motor rotating a screwing tool or rotating or translating a cutting tool according to an angle or to a depth of drilling or to time;
a force according to an angle or to a depth of drilling or to time.

17. The method according to claim 14, comprising selecting, in each of said series, a portion of data of interest, said portion of data of interest being the subject of said preprocessing.

18. A device comprising:
at least one processor; and
at least one non-transitory computer readable medium comprising instructions stored thereon which when executed by the at least one processor configure the device to implement a method of controlling the quality of the screwing or drilling operations performed by using the tool, said method comprising:
machine learning of a model, said initial machine learning comprising:
collecting initial results of screwing or drilling operations recorded during a plurality of screwing or drilling operations;
obtaining, by using said model, at least one statistical representation of at least some of the initial results;
labelling said at least one statistical representation with at least one of said following labels:
labelled statistical representation of conforming results;
labelled statistical representation of non-conforming results;
automatic production control of the quality of screwing or drilling operations, said automatic production control being implemented at an end of each operation and comprising:
collecting a new result of the screwing or drilling operation recorded during the operation in question;
automatic allocation of said new result of the operation in question to the at least one statistical representation;
issuing an alert in response to the new operation result being allocated to a non-conforming statistical representation;
wherein said learning of said model is of an unsupervised type.

19. The device according to claim 18, wherein the method comprises rejecting the new results of operations that cannot be allocated in production to one of said statistical representations, and recording the rejected results as exception results.

20. The device according to claim 19, wherein the method comprises issuing an alert in response to a new result obtained at the end of a screwing or drilling operation being identified as an exception result during said rejecting.

21. The device according to claim 18, wherein said obtaining at least one statistical representation uses a statistical model of the Gaussian mixture model type, said at least one statistical representation being a multivariate normal law.

22. The device according to claim 18, wherein said obtaining at least one statistical representation uses a statistical model of the k-means type, said at least one statistical representation being a mean vector.

23. The device according to claim 21, wherein said production control comprises rejecting the new results of operations that cannot be allocated to one of said statistical representations, and recording the rejected results as exception results, and wherein said statistical model of the Gaussian mixture type is able to calculate a plurality of initial multivariate normal laws each representing a cluster of initial results of screwing or drilling operations, each of said initial multivariate normal laws having a weight, said rejecting comprising calculating a probability density of each new result of a screwing or drilling operation obtained in production and comparing this density with a predetermined global rejection threshold dependent on the weight of each of said initial multivariate normal laws.

24. The device according to claim 23, wherein said weight of an initial multivariate normal law represents a number of results of screwing or drilling operations allocated to said multivariate normal law with respect to a total number of results of screwing or drilling operations taken into account.

25. The device according to claim 23, wherein the method comprises updating the weight of all of said initial multivariate normal laws.

26. The device according to claim 23, wherein the method comprises updating said predetermined global rejection threshold.

27. The device according to claim 23, wherein the method comprises updating the at least one statistical representation of the initial results in the form of at least one multivariate normal law obtained by said learning, said updating taking account of the new results of operations identified as exception results for generating at least one new multivariate normal law.

28. The device according to claim 27, wherein said updating said statistical model of the Gaussian mixture type comprises calculating new multivariate normal laws, from the exception results, each representing a new cluster of results of operations, said updating said statistical model comprising calculating the new weight of said initial and new multivariate normal laws.

29. The device according to claim 27, wherein said updating generates new multivariate normal laws, from the new results of operations and the initial results of operations, each representing a new cluster of results of screwing or drilling operations, said new multivariate normal laws being substituted for the initial multivariate normal laws.

30. The device according to claim 27, comprising counting a number of new results of operations identified as exception results, said updating being used when the number of results of operations identified as exception results reaches a predetermined threshold.

31. The device according to claim 18, wherein each operation result comprises a series of data, said method comprising preprocessing said series of data comprising doing, on the series of data, a series of predetermined calculations each leading to an extracted characteristic, said extracted characteristics being taken into consideration by said obtaining the statistical representation of the initial results in the form of at least one multivariate normal law.

32. The device according to claim 23, wherein each operation result comprises a series of data, said series of data being a subject of preprocessing comprising doing, on the series of data, a series of predetermined calculations each leading to an extracted characteristic, said extracted characteristics being taken into consideration for implementing said obtaining the statistical representation of the initial results in the form of at least one multivariate normal law, and wherein said extracted characteristics are taken into consideration by said statistical model of the Gaussian mixture type for generating said multivariate normal laws each representing a cluster of results of screwing or drilling operations.

33. The device according to claim 31, wherein said series of data belong to a group consisting of:
a torque according to an angle or to a depth of drilling or to time;
an angle as a function of time;
a current, in particular of a motor rotating a screwing tool or rotating or translating a cutting tool according to an angle or to a depth of drilling or to time;
a force according to an angle or to a depth of drilling or to time.

34. The device according to claim 31, comprising selecting, in each of said series, a portion of data of interest, said portion of data of interest being taken into account by said preprocessing.

35. (canceled)

36. A storage medium that can be read by computer and is non-transient, storing a computer program product comprising program code instructions for implementing a method for controlling quality of screwing or drilling operations performed by using a tool, when the instructions are executed by a computer, wherein the method comprises:
machine learning of a model, said initial machine learning comprising:
collecting initial results of screwing or drilling operations recorded during a plurality of screwing or drilling operations;
obtaining, by using said model, at least one statistical representation of at least some of the initial results;
labelling said at least one statistical representation with at least one of said following labels:
labelled statistical representation of conforming results;
labelled statistical representation of non-conforming results;
automatic production control of the quality of screwing or drilling operations, said automatic production control being implemented at an end of each operation and comprising:
collecting a new result of the screwing or drilling operation recorded during the operation in question;
automatic allocation of said new result of the operation in question to the at least one statistical representation;
issuing an alert in response to the new operation result being allocated to a non-conforming statistical representation;
wherein said learning of said model is of an unsupervised type.
